(19) United States
(12) Patent Application Publication
(10) Pub. No.: US 2022/0381513 A1
(43) Pub. Date: Dec. 1, 2022

(54) REFRACTORY LAYER FOR INSULATION AND CONDUCTION IN INDUSTRIAL FURNACES

(71) Applicant: HarbisonWalker International Holdings, Inc., Moon Township, PA (US)

(72) Inventors: Bryn Christine Snow, Bridgeville, PA (US); Donald Abrino, Curwensville, PA (US)

(73) Assignee: HarbisonWalker International Holdings, Inc., Moon Township, PA (US)

(21) Appl. No.: 17/329,699

(22) Filed: May 25, 2021

(51) Int. Cl. F27B 14/10; F27B 14/08

(52) U.S. Cl. CPC F27B 14/10; F27B 14/08; F27B 2014/104; F27B 2014/102

(57) ABSTRACT

An industrial furnace for melting materials is provided. The industrial furnace includes metal components, a refractory shell, and a fill. The refractory shell is positioned to cover an inner surface of the metal components such that one or more pockets are defined between the metal components and the refractory shell. The refractory shell has an inner surface that substantially defines a melting bath in which the materials are deposited for melting. The fill is disposed in each of the pockets. 90% to 99.5% of the fill is composed of one or more magnesia materials selected from the group consisting of dead-burned magnesia and fused magnesia.

### FIELD OF THE INVENTION

The present invention relates generally to industrial furnaces for melting materials in which electrical current flow is prevalent, and, more particularly, to the insertion of magnesia refractory fill in the walls of such industrial furnaces.

### BACKGROUND OF THE INVENTION

Industrial furnaces often use electrodes from an open top thereof for the melting various kinds of materials. Examples of such furnaces are kettle furnaces or cold top furnaces, which can be used to melt glass for production of fiberglass. Such a furnace can have a center drain or use a conventional submerged throat to move molten glass from the furnace to the forming process.

The electrodes are oriented above the furnace and used to melt the glass in the furnace. The electrodes are submerged into the molten glass and continue to melt glass as batches of non-molten glass are fed into the furnace from the top as the molten glass is removed through the throat from the bottom of the furnace.

The inside surfaces of metal shells defining these furnaces are lined with a refractory. Oxides such as alumina chrome and alumina zirconia and other refractory materials resistant to the corrosion of molten glass can be used as refractory lining. The refractory lining can be installed in contact with the metal shell surfaces in such a way to ensure good heat transfer from the refractory lining, thereby enhancing the cooling of the refractory and reducing the damage that can occur as a result of exposure to corrosive molten glass.

The oxides mentioned above, for the most part, are considered to be electrical insulators, which would also be a requirement for the use of other refractory materials resistant to the corrosion of molten glass referenced above. However, such materials still have enough conductivity to let some electrical energy leak from the molten glass to the metal shell and out of the furnace. This electrical energy leakage results in the wasting of energy that is intended to be used for the melting of the glass.

One solution to inhibit electrical energy leakage is to install a more electrically resistant material between the refractory lining and the metal shell. This electrical insulation layer must be able to provide an electrical energy resistivity at temperatures between 250° F. and 1000° F. Conventional materials, such as mica board and silica fabric, can be used as electrical insulation layers.

However, materials such as this also serve as a thermal insulator between the metal shell and the refractory lining. This thermal insulation results in an increased mean temperature of the refractory lining, which can result in increased corrosion rates and deeper penetration of the molten glass into the refractory lining, both in the material itself and between any joints in the refractory lining that may exist. Because of this drawback, most furnaces are constructed without such electrically resistant materials, and electrical leakage is tolerated as a lesser drawback.

The present invention has been developed to address these and other issues by providing a magnesia refractory fill between a refractory lining configured to be in contact with molten glass and a metal shell surrounding the refractory lining. The magnesia refractory fill has a high electrical resistivity and a high thermal conductivity that can withstand the service temperatures in the industrial furnace, maintain the electrical resistivity and thermal conductivity characteristics across the service temperatures, and be successfully installed between the refractory lining and the metal shell in an electric melting operation in which one or more materials, such as glass, are melted.

### SUMMARY OF THE INVENTION

In accordance with an embodiment of the present invention, an industrial furnace for melting materials is provided. The industrial furnace includes metal components, a refractory shell, and a fill. The refractory shell is positioned to cover an inner surface of the metal components such that one or more pockets are defined between the metal components and the refractory shell. The refractory shell has an inner surface that substantially defines a melting bath in which the materials are deposited for melting. The fill is disposed in each of the pockets. 90% to 99.5% of the fill is composed of one or more magnesia materials selected from the group consisting of dead-burned magnesia and fused magnesia.

In accordance with another embodiment of the present invention, there is provided a method of manufacturing an industrial furnace for melting materials. In the method, metal components having a metal floor and a metal sidewall are provided. An inner surface of the metal components is covered with a refractory shell. The refractory shell has a floor refractory lining covering an inner surface of the metal floor and a sidewall refractory lining covering an inner surface of the metal sidewall such that a side pocket is defined between the metal sidewall and the sidewall refractory lining. A fill is disposed in side pocket. The refractory shell has an inner surface that substantially defines a melting bath in which the materials are deposited for melting. The refractory shell is configured to inhibit exposure of the metal components to the materials. 90% to 99.5% of the fill is composed of one or more magnesia materials selected from the group consisting of dead-burned magnesia and fused magnesia.

In accordance with yet another embodiment of the present invention, there is provided a method of manufacturing an industrial furnace for melting materials. In the method, metal components having a metal floor and a metal sidewall are provided. A layer of fill is disposed on the metal floor. An inner surface of the metal components is then covered by a refractory shell. The refractory shell has a floor refractory lining covering the fill layer and an inner surface of the metal floor to form a floor pocket between the metal floor and the floor refractory lining. The refractory shell further has a sidewall refractory lining covering an inner surface of the metal sidewall such that a side pocket is defined between the metal sidewall and the sidewall refractory lining. The refractory shell has an inner surface that substantially defines a melting bath in which the materials are deposited for melting. The refractory shell is configured to inhibit exposure of the metal components to the materials. The fill is then disposed in the side pocket. 90% to 99.5% of the fill is composed of one or more magnesia materials selected from the group consisting of dead-burned magnesia and fused magnesia.

The present invention provides a solution for the flaws of other approaches to addressing inhibition of electricity loss between metal components and a refractory shell in an electric melting operation in which one or more materials, such as glass, are melted.

These and other features will become apparent from the following description of preferred embodiments taken together with the claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a perspective view illustrating an example industrial furnace according to the present invention;

FIG. 2 is a top view illustrating an example industrial furnace according to the present invention;

FIG. 3 is a flowchart illustrating an example of a method of manufacturing an industrial furnace for melting materials in accordance with a first embodiment;

FIG. 4 is a cross-sectional view 4-4 of FIG. 2 illustrating an initial step of a method of manufacturing an industrial furnace for melting materials in accordance with the first embodiment and a second embodiment;

FIG. 5 is a cross-sectional view 4-4 of FIG. 2 illustrating an additional step of a method of manufacturing an industrial furnace for melting materials in accordance with the first embodiment;

FIG. 6 is a cross-sectional view 4-4 of FIG. 2 illustrating the first embodiment of an industrial furnace according to the present invention and a further step of a method of manufacturing an industrial furnace for melting materials in accordance with the first embodiment;

FIG. 7 is a flowchart illustrating an example of a method of manufacturing an industrial furnace for melting materials in accordance with a second embodiment;

FIG. 8 is a cross-sectional view 4-4 of FIG. 2 illustrating an additional step of a method of manufacturing an industrial furnace for melting materials in accordance with the second embodiment;

FIG. 9 is a cross-sectional view 4-4 of FIG. 2 illustrating a further step of a method of manufacturing an industrial furnace for melting materials in accordance with the second embodiment; and

FIG. 10 is a cross-sectional view 4-4 of FIG. 2 illustrating the second embodiment of an industrial furnace according to the present invention and yet another step of a method of manufacturing an industrial furnace for melting materials in accordance with the second embodiment.

### DETAILED DESCRIPTION OF PREFERRED EMBODIMENTS

The following detailed description is provided to assist the reader in gaining a comprehensive understanding of the compositions and methods described herein. However, various changes, modifications, and equivalents of the compositions and methods described herein will be apparent to one of ordinary skill in the art. In addition, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

For example, it is additionally noted that the drawings might not be to scale and may be simplified in order to provide a better understanding of the present invention. Certain elements illustrated in the drawings may be enlarged or minimized in order to properly illustrate the features of the invention. Further, certain features illustrated in the drawings may be generalized to enhance understanding of the present invention. In addition, the illustrations may not include some features known to one having ordinary skill in the art so that inventive feature may be more particularly displayed.

While much of the description going forth will use glass as an example material being disposed in the industrial furnace for melting, embodiments disclosed herein are not limited thereto. For example, the industrial furnace described herein can be used in conjunction with the melting of any material known to one having ordinary skill in the art to be compatible with such an industrial furnace.

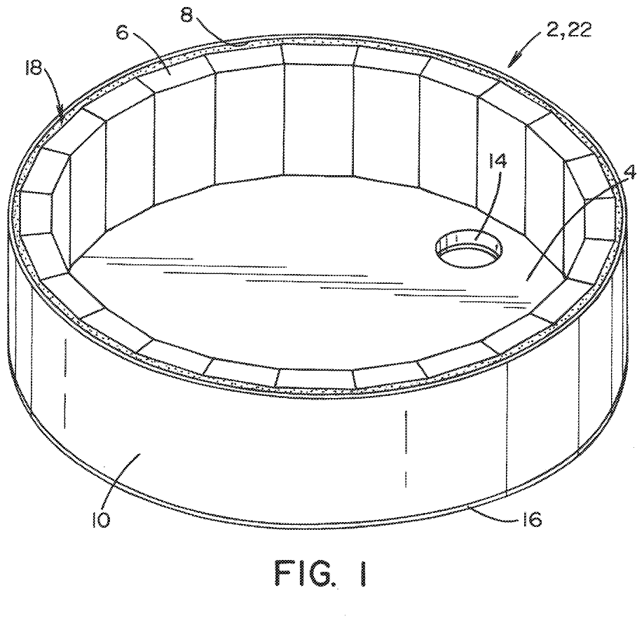

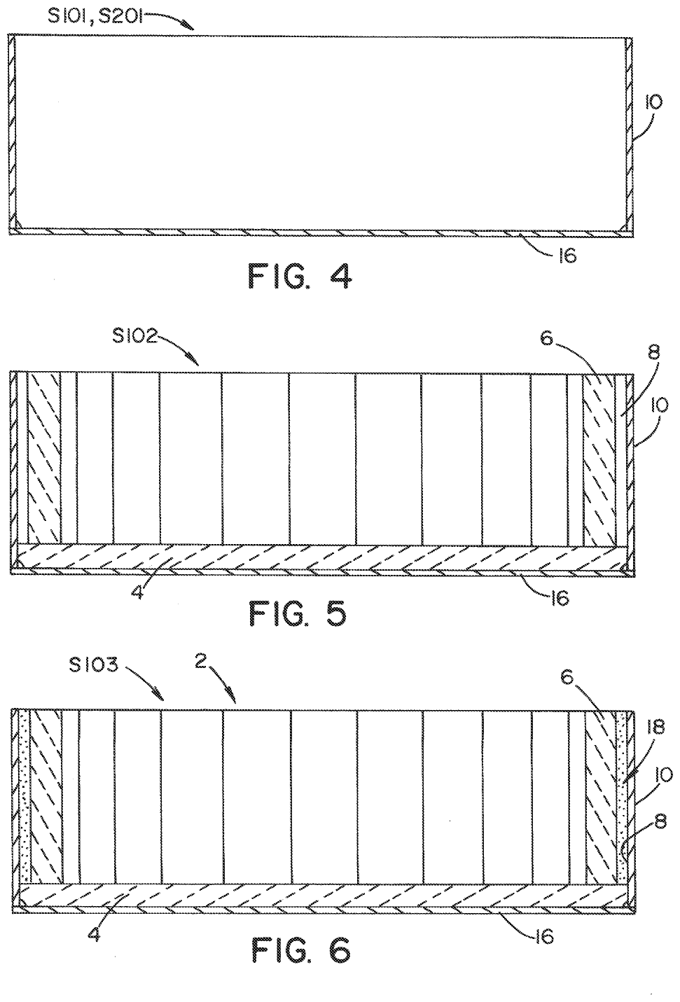

It is noted that, in the discussion below, while FIG. 4 represents industrial furnaces 2 and 22 and respective steps S101 and S201 of methods 100 and 200 of manufacturing industrial furnaces 2 and 22 described here below, the features of industrial furnace 22, as well as method 200 of manufacturing industrial furnace 22 and steps S201, S202, S203, and S204 thereof, will be more particularly described with respect to FIGS. 1, 2, 4, and 7-10 after the description related to industrial furnace 2 and method 100 of manufacturing thereof.

Referring now to the drawings, wherein the showing is for illustrating a preferred embodiment of the invention only and not for limiting same, a first embodiment of the invention will be described with reference to FIGS. 1-6.

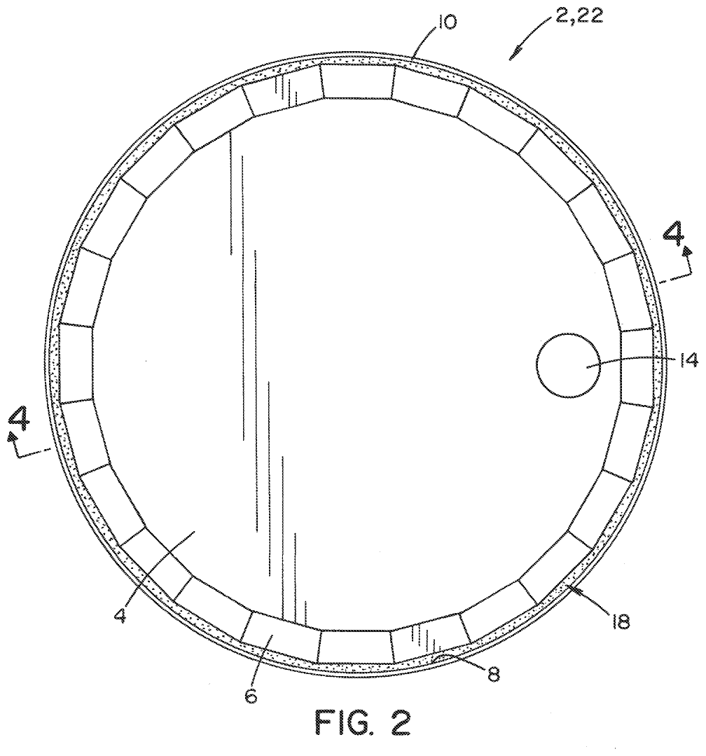

FIG. 1 is a perspective view illustrating industrial furnace 2, as well as industrial furnace 22. FIG. 2 is a top view illustrating industrial furnace 2, as well as industrial furnace 22.

Industrial furnace 2 may be used for melting materials such as glass. Industrial furnace 2 includes floor refractory lining 4, sidewall refractory lining 6, metal sidewall 10, metal floor 16, throat area 14, side pocket 8, and magnesia fill 18.

Metal sidewall 10 and metal floor 16 are defined by metal components of industrial furnace 2. In an example, metal sidewall 10 and metal floor 16 may be formed in a way as to define a metal shell. As such, metal sidewall 10 and metal floor 16 may be fused together to define a metal shell or formed as a metal shell in one integral piece. In another example, metal sidewall 10 and metal floor 16 may be defined by metal grating or metal bars.

Going forward in this description, for purposes of example, metal sidewall 10 and metal floor 16 are described and illustrated in a such a way as to define a metal shell composed thereof. However, as was noted above, embodiments disclosed herein are not limited thereto, as metal floor 16 and metal sidewall 10 may be defined by any combination of metal components known by one having ordinary skill in the art to be suitable for open top furnaces in which one or more materials, such as glass, are melted.

In another example, metal sidewall 10 and metal floor 16 are composed of steel. However, embodiments disclosed herein are not limited thereto, as the metal shell may be composed of any material known by one of having ordinary skill in the art to be suitable for open top furnaces in which one or more materials, such as glass, are melted.

Metal sidewall 10 extends away from metal floor 16 in a plane that bisects a plane in which metal floor extends 16. Floor refractory lining 4 is positioned to cover an inner surface of metal floor 16. Sidewall refractory lining 6 is positioned to cover an inner surface of metal sidewall 10 and extend away from floor refractory lining 4 in a plane that bisects a plane in which floor refractory lining 4 extends. Floor refractory lining 4 and sidewall refractory lining 6 together make up a refractory shell positioned in the metal shell. An inner surface of the refractory shell substantially defines a melting bath in which materials, such as glass, are deposited for melting. The refractory shell inhibits exposure of the metal shell to corrosive molten materials, such as molten glass, melted within industrial furnace 2. Throat area 14 is an outlet of industrial furnace 2 that allows connection of industrial furnace 2 to a channel (not shown) that takes the molten materials, such as molten glass, to forming equipment (not shown).

In the example embodiment illustrated in FIGS. 1 and 2, as well as FIGS. 5 and 6 to be discussed further below, floor refractory lining 4 is placed in direct contact with metal floor 16. However, sidewall refractory lining 6 is positioned to cover the inner surface of metal sidewall 10 such that side pocket 8 is defined between metal sidewall 10 and sidewall refractory lining 6.

Floor refractory lining 4 is illustrated in FIGS. 1 and 2, as well as FIGS. 5 and 6 to be discussed further below, as a monolithic structure, but is not limited thereto. Sidewall refractory lining 6 is illustrated in FIGS. 1 and 2, as well as FIGS. 5 and 6 to be discussed further below, as a plurality of refractory panel structures, but is not limited thereto.

For example, refractory linings 4 and 6 may be integrally formed or varied in configuration, in that various portions or an entirety of the refractory shell may be composed of refractories that are formed and installed according to several methods or orientations and include a variety of refractory materials known to one having ordinary skill in the art. Primarily, it is the refractory material composing the refractory shell, and not the configuration or the orientation thereof, that is critical in protecting the metal shell from exposure to corrosive molten materials, such as molten glass, melted within industrial furnace 2.

The refractory material from which the refractory shell is composed may include sources of alumina and silica, such as, but not limited to, aluminum oxides, nesosilicates, phyllosilicates, fireclays, chamottes, bauxites, and silica sands. Examples of such aluminum oxides include alumina chrome, alumina zirconia calcined aluminas, which may include, but are not limited to, tabular aluminas and bubble aluminas. Examples of such nesosilicates may include, but are not limited to, kyanites, mullites, and other nesosilicates. Examples of such phyllosilicates may include, but are not limited to, clay minerals, such as pyrophyllites, and other phyllosilicates. In some situations, sources of calcium oxides (e.g., lime), magnesias, dolomites, titania, iron oxides, and iron alkalis may also be found in the refractory shell. One having ordinary skill in the art would contemplate other materials and combinations of materials that could be implemented for use in the refractory shell that could be used to inhibit or delay corrosion common caused by molten materials, such as molten glass.

Magnesia fill 18 is disposed in side pocket 8. Magnesia fill 18 serves to favorably support sidewall refractory lining 6, ensure heat transfer from sidewall refractory lining 6 to metal sidewall 10, and act as a highly efficient electrical insulator between the sidewall refractory lining 6 and metal shell 18 in an electric melting operation in which one or more materials, such as glass, are melted.

In an example, 90% to 99.5% of magnesia fill 18 is composed of one or more magnesia materials selected from the group consisting of dead-burned magnesia and fused magnesia. The magnetic materials should be free of any magnetic metal before being blended into a final magnesia fill 18, as free metal will result in enhanced electrical conductivity, thereby defeating the purpose of making magnesia fill 18 have dead-burned magnesia and fused magnesia as a main component.

Depending on the amount of magnesia contained therein, magnesia fill 18 may also include other oxides in varying quantities, such as approximately 0.6% to 2.0% of CaO, approximately 0.1% to 2.0% of Al₂O₃, approximately 0.2% to 5.0% of SiO₂, approximately 0.2% to 2.0% of Fe₂O₃, or trace amounts of other oxides, such as TiO₂, Cr₂O₃, B₂O₃, MnO, or P₂O₅. Binders such as soda, boron, or other fluxes known to those having ordinary skill in the art may be considered for use in magnesia fill 18. However, the inclusion of such non-MgO oxides and binders in magnesia fill 18 is limited to avoid any potential negative impact such compounds could have on the performance of magnesia fill 18 with respect to electrical resistivity.

It is ideal that magnesia fill 18 is as pure as possible. In addition, magnesia fill 18 is well compacted to ensure that the above-referenced electrical and thermodynamic properties are obtained in this application. Magnesia fill 18 is a granular to powder material according to the above-referenced composition requirements and is sized in such a way to achieve high density in side pocket 8 by vibration, tapping, or other mechanical means known to one having ordinary skill in the art

To ensure good compaction of magnesia fill 18, magnesia fill 18 must be sized properly. The exact sizing must be adjusted based on the thickness of width of side pocket 8 and, subsequently, the thickness of magnesia fill 18 in side pocket 8. In one example, magnesia fill 18 may be optimized normally with a top material size of not more than 0.25 inches in diameter. Compaction of magnesia fill 18 can be further optimized by using smaller material sizes, which is anticipated.

Table 1 represents testing that was performed on a variety of magnesia dry vibes that may be applied as the aforementioned magnesia materials in magnesia fill 18. Dry Vibe 1 consisted of a fine, 100%-fused magnesia powder. Dry Vibe 2 consisted of coarse 100%-fused magnesia granules. Dry vibe 3 consisted of 100%-fused magnesia granules that was coarser than Dry Vibe 2. Dry Vibe 4 consisted of a fine powder having fused magnesia with fine, sintered magnesia. Dry Vibe 5 consisted of coarse granules having fused magnesia with fine, sintered magnesia. Dry Vibe 6 consisted of granules having fused magnesia with fine, sintered magnesia that were coarser than the granules in Dry Vibe 5.

Alternate tests on the dry vibes were performed using compaction through vibration (Loose Fill Density and Packed Density) and tapping (Loose Fill Density through Funnel and Tapped Density). An angle of repose was determined for each of the dry vibes. In addition, a theoretical screen analysis was performed on 200 g of each of the dry vibe samples, in which the amount in weight of the dry vibe samples to be subsequently caught on the respective screen was recorded, with the remaining amount of the 200 g of each of the dry vibe samples not caught by a screen passing completely through the −200 M screen and being washed out.

The packed densities achieved through vibration compaction of each of the dry vibes are considered to be high. While that is the case, the Hausner Ratios obtained through vibration compaction of each of the dry vibes are equal to or less than 1.25, which indicates that the dry vibes having the high packed densities additionally have good flowabilities, thereby enabling magnesia fill 18 to be transported into side pocket 8 as efficiently as possible.

TABLE 1

| | | | | 4 | 5 | 6 |
|---|---|---|---|---|---|---|
| | | | | Fine - | Coarse - | Coarsest- |
| | 1 | 2 | 3 | Fused with | Fused with | Fused with |
| | Fine- | Coarse- | Coarsest- | Fine | Fine | Fine |
| | 100% | Fused | Fused | Sintered | Sintered | Sintered |
| Description | Fused | 100% | 100% | MgO | MgO | MgO |
| Loose Fill | 132.7 | 133.9 | 135.9 | 130.7 | 132.8 | 135.0 |
| Density (lb/ft³) | | | | | | |
| Packed Density | 158.8 | 157.9 | 157.4 | 164.0 | 163.8 | 166.1 |
| (lb/ft³) | | | | | | |
| Hausner Ratio | 1.20 | 1.18 | 1.16 | 1.25 | 1.23 | 1.23 |
| (Packed/LFBD) | | | | | | |
| Loose Fill | 134.5 | 124.1 | 138.7 | 126.7 | 129.6 | 135.5 |
| Density through | | | | | | |
| Funnel (lb/ft³) | | | | | | |
| Tapped Density | 160.5 | 162.9 | 158.9 | 164.9 | 165.9 | 164.8 |
| 2500 taps (lb/ft³) | | | | | | |
| Hausner Ratio | 1.19 | 1.18 | 1.15 | 1.30 | 1.28 | 1.22 |
| (Tapped/Loose) | | | | | | |
| Angle of Repose | 42.2 | 41.2 | 41.6 | 45.4 | 48.9 | 48.0 |

Theoretical Screens

| | | | | | | |
|---|---|---|---|---|---|---|
| ON 6 | 0 | 0 | 0 | 0 | 0 | 0 |
| 6 × 14 | 23 | 25 | 28 | 20 | 25 | 28 |
| 14 × 48 | 34 | 35 | 37 | 30 | 31 | 33 |
| 48 × 100 | 18 | 17 | 15 | 9 | 10 | 11 |
| −100M | 25 | 23 | 20 | 40 | 34 | 28 |
| −200M | 7 | 7 | 6 | 29 | 23 | 16 |

The tamped densities achieved through performing compaction through tapping of each of the dry vibes are also considered to be high. Dry Vibes 4 and 5 possessed Hausner Ratios above 1.25, which suggests that loose fill densities of Dry Vibes 4 and 5 are too low to achieve good flowability through tapping compaction. However, the remainder of the dry vibes subject to tapping compaction possesses Hausner Ratios that are less than 1.25, indicating good flowability. The angle of repose of the dry vibes additionally suggests better flowability at lower angles. Dry Vibes 1-3 possessed similar angles of repose. Dry-Vibes 1-3 also possessed lower angles of repose than Dry Vibes 4-6, suggesting that the 100% fused magnesia is smoother and more rounded than the combination of fused magnesia and fine sintered magnesia, even when the 100% fused magnesia is at its coarsest.

It is noted that, for comparative purposes, a graphite-based fill may have a bulk density in a range of 108 lb/ft³ to 137 lb/ft³. The grain size of the comparative graphite-based fill may be in a range of 4 mm to 5 mm. The thermal conductivity of the comparative graphite-based fill may be in a range of 16 W/mK to 18 W/mK, and the graphite-based fill may have an electrical resistivity at 1000° C. of about 8×10⁻⁶. Magnesia fill 18 including one or more of the above-referenced dry vibes may have a bulk density in a range of 125 lb/ft³ and 170 lb/ft³, a grain size that is less than 6.4 mm, and a thermal conductivity in a range of 4.3 W/mK to 5.8 W/mK., which is approximately four times more thermally insulating than the above-referenced graphite-based fill. It is known by those having ordinary skill in the art that standard non-basic refractories have a thermal conductivity in a range from 1 W/mK to 3 W/mK. In addition, a 50% chrome alumina has a thermal conductivity in a range from about 2.3 W/mK to 2.5 W/mK. Insulating refractories will typically have a thermal conductivity of less than 0.5 W/mK. In view of this, while the thermal conductivity of magnesia fill 18 is somewhat reduced in comparison with the graphite fill, the thermal conductivity of magnesia fill 18 is still within an acceptable range to enable satisfactory heat transfer from the melting bath therethrough.

However, the contrast between the electrical resistivity of magnesia fill 18 and that of the graphite fill is significant. While the electrical resistivity of the graphite-based fill at 1000° C. is about 8×10⁻⁶, the electrical resistivity of magnesia fill 18 at 1000° C. is in a range of 3×10² and 1×10⁵. As such, at 1000° C., in contrast with the graphite-based fill, magnesia fill 18 is effective at resisting electrical loss in industrial furnace 2 while also conducting heat from industrial furnace 2.

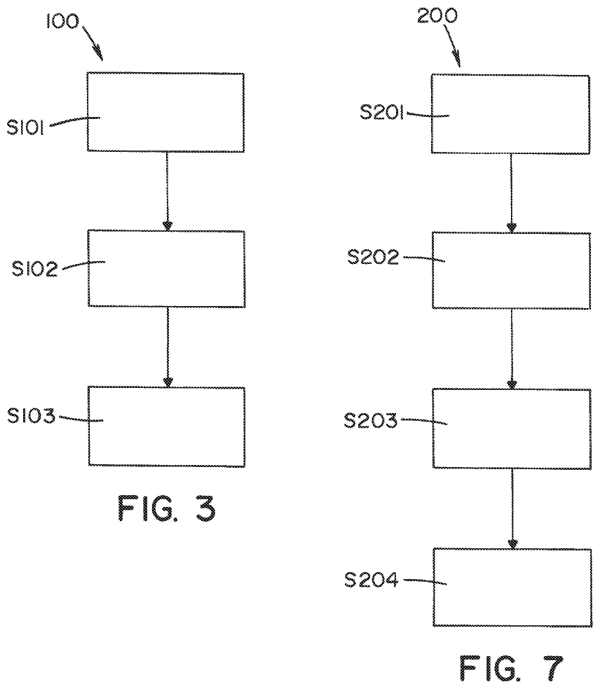

In accordance with an example embodiment illustrated in FIGS. 3-6, method 100 of manufacturing industrial furnace 2 for melting materials will now be described. FIG. 3 is a flowchart illustrating an example of method 100 of manufacturing industrial furnace 2 for melting materials FIG. 4 is a cross-sectional view 4-4 of FIG. 2 illustrating an initial step S101 of method 100 of manufacturing industrial furnace 2, as well an initial step S201 of method 200 of manufacturing industrial furnace 22. FIG. 5 is a cross-sectional view 4-4 of FIG. 2 illustrating an additional step (S102) of method 100 of manufacturing industrial furnace 2. FIG. 6 is a cross-sectional view 4-4 of FIG. 2 illustrating industrial furnace 2 as featured in FIGS. 1 and 2 and a further step (S103) of method 100 of manufacturing industrial furnace 2.

First, the metal shell composed of metal floor 16 and metal sidewall 10 is provided (S101). Then, an inner surface of the metal shell is covered (S102) with a refractory shell respectively composed of floor refractory lining 4 and sidewall refractory lining 6. The refractory shell has an inner surface that substantially defines a melting bath in which the materials are deposited for melting. The refractory shell is configured to inhibit exposure of the metal shell to the materials.

The covering (S102) of the metal shell with the refractory shell is performed such that side pocket 8 is defined between the metal shell and the refractory shell, specifically between metal sidewall 10 and sidewall refractory lining 6. Side pocket 8 may have a width between metal sidewall 10 and sidewall refractory lining 6 that is greater than 0.25 in and less than 1.0 in, but more preferably lies in a range between 0.5 in and 1.0 in.

Then, magnesia fill 18 is disposed (S103) in side pocket 8. Magnesia fill 18 is 90% to 99.5% composed of dead-burned magnesia, fused magnesia, or a combination thereof. Magnesia fill 18 is slowly poured into side pocket 8 between sidewall refractory lining 6 and metal sidewall 10. As magnesia fill 18 is poured into side pocket 8, magnesia fill 18 is also compacted by vibration or tapping.

Referring now to the drawings, wherein the showing is for illustrating a preferred embodiment of the invention only and not for limiting same, a second embodiment of the invention will be described with reference to FIGS. 1, 2, 4, and 7-10.

Industrial furnace 22 includes floor refractory lining 4, sidewall refractory lining 6, metal sidewall 10, metal floor 16, throat area 14, side pocket 8, floor pocket 20, and magnesia fill 18. It is noted that a description of many details of industrial furnace 22 will be omitted, as those features substantially correspond with the previously described features of industrial furnace 2. For example, floor pocket 22, magnesia fill 18 disposed within floor pocket 22, and method 200 of manufacturing industrial furnace 22 are the only substantial respective distinctions between industrial furnace 2 and method 100 of manufacturing thereof and industrial furnace 22 and method 22 of manufacturing thereof. That being said, as previously noted and repeated for emphasis, one having ordinary skill in the art would recognize the known elements of industrial furnaces 2 and 22 and methods 100 and 200 that are not displayed herein for clarity and conciseness.

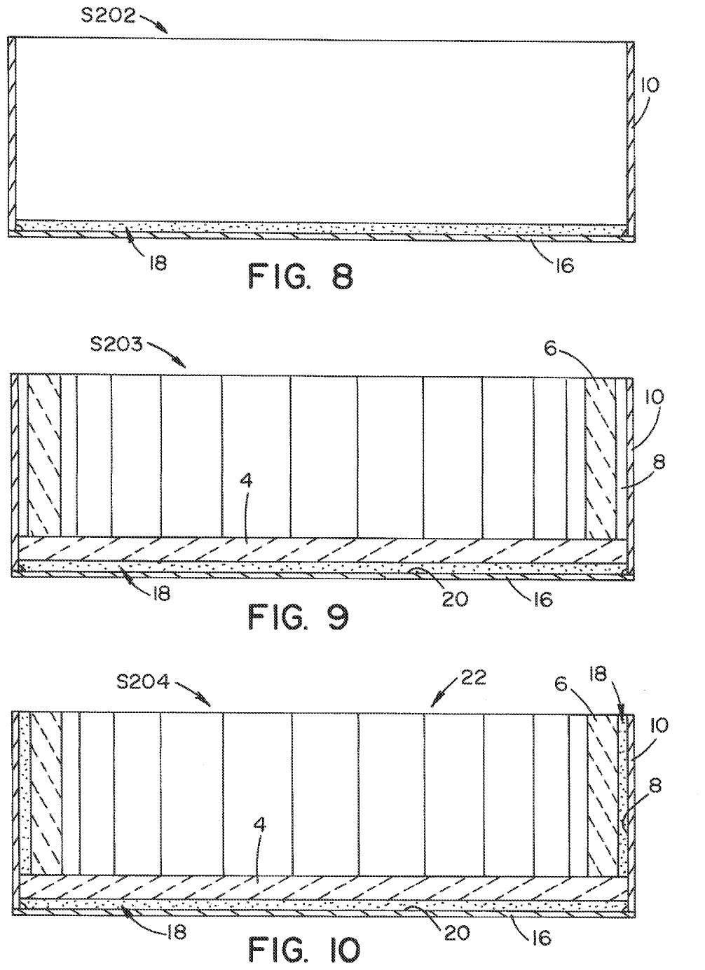

As is illustrated in FIGS. 8-10, floor pocket 20 is defined between floor refractory lining 4 and metal floor 16 for the disposition of magnesia fill 18 therein, thereby serving the same purpose of electrical resistivity permitting thermal conductivity as is achieved in side pocket 8.

In accordance with an example embodiment illustrated in FIGS. 4 and 7-10, method 200 of manufacturing industrial furnace 22 for melting materials will now be described. FIG. 4 is a cross-sectional view 4-4 of FIG. 2 illustrating an initial step S201 of method 200 of manufacturing industrial furnace 22, as well an initial step S101 of previously described method 100 of manufacturing industrial furnace 2. FIG. 7 is a flowchart illustrating an example of method 200 of manufacturing industrial furnace 22 for melting materials. FIG. 8 is a cross-sectional view 4-4 of FIG. 2 illustrating an additional step (S202) of method 200 of manufacturing industrial furnace 22. FIG. 9 is a cross-sectional view 4-4 of FIG. 2 illustrating a further step (S203) of method 200 of manufacturing industrial furnace 22. FIG. 10 is a cross-sectional view 4-4 of FIG. 2 illustrating industrial furnace 22 as featured in FIGS. 1 and 2 and yet another step (S204) of method 200 of manufacturing industrial furnace 22.

First, the metal shell composed of metal floor 16 and metal sidewall 10 is provided (S201). Then, magnesia fill 18 is disposed (S202) on metal floor 16. As previously noted, magnesia fill 18 is 90% to 99.5% composed of dead-burned magnesia, fused magnesia, or a combination thereof. Magnesia fill 18 is slowly poured onto metal floor 16 while also being compacted by vibration or tapping. A layer of magnesia fill 18 disposed on metal floor 16 has a thickness above metal floor 16 that may be greater than 0.25 inch and less than 2.0 in, but more preferably in a range between 0.75 in and 2.0 in.

Then, an inner surface of the metal shell, as well as magnesia fill 18 compacted on metal floor 16, is covered (S203) with a refractory shell respectively composed of floor refractory lining 4 and sidewall refractory lining 6. The refractory shell has an inner surface that substantially defines a melting bath in which the materials are deposited for melting. The refractory shell is configured to inhibit exposure of the metal shell to the materials.

As previously noted with respect method 100, the covering (S203) of the metal shell with the refractory shell is performed such that side pocket 8 is defined between the metal shell and the refractory shell, specifically between metal sidewall 10 and sidewall refractory lining 6, and floor pocket 20 is defined between floor refractory lining 4 and metal floor 16. Side pocket 8 may have a thickness similar to that which was previously described with respect to method 100. Then, magnesia fill 18 is further disposed (S204) in side pocket 8 in accordance with the previously defined disposal (S103) of method 100.

It is noted that, while not specifically addressed herein, it would be conceivable to one having ordinary skill in the art to position water-cooled panels (not shown) on metal floor 16 and water-cooled jackets (not shown) on metal sidewall to further facilitate heat transfer from the melting bath.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof

1. An industrial furnace for melting materials, comprising:
metal components; and
a refractory shell positioned to cover an inner surface of the metal components such that one or more pockets are defined between the metal components and the refractory shell, the refractory shell having an inner surface that substantially defines a melting bath in which the materials are deposited for melting, the refractory shell being configured to inhibit exposure of the metal components to the materials; and
a fill disposed in each of the pockets,
wherein 90% to 99.5% of the fill is composed of one or more magnesia materials selected from the group consisting of dead-burned magnesia and fused magnesia.

2. The industrial furnace according to claim 1, wherein the metal components comprise a metal floor and a metal sidewall, and
wherein the refractory shell comprises a floor refractory lining and a sidewall refractory lining positioned to cover respective inner surfaces of the metal floor and the metal sidewall, and
wherein the sidewall refractory lining is positioned to cover the inner surface of the metal sidewall such that a side pocket of the pockets is defined between the metal sidewall and the sidewall refractory lining.

3. The industrial furnace according to claim 2, wherein the floor refractory lining is positioned to cover the metal floor and a layer of the fill deposited on the metal floor such that a floor pocket of the pockets is defined between the metal floor and the floor refractory lining containing the fill therein.

4. The industrial furnace according to claim 3, wherein the fill layer deposited on the metal floor has a thickness above the metal floor that is in a range of 0.75 in to 2.0 in.

5. The industrial furnace according to claim 2, wherein the side pocket has a width between the metal sidewall and the sidewall refractory lining that is in a range of 0.5 in to 1.0 in.

6. The industrial furnace according to claim 1, wherein the fill is further composed of one or more materials selected from the group consisting of CaO, Al₂O₃, SiO, Fe₂O₃, TiO₂, Cr₂O₃, B₂O₃, MnO, P₂O₅, soda binders, and boron binders.

7. The industrial furnace according to claim 2, wherein the metal sidewall and the metal floor define a metal shell.

8. A method of manufacturing an industrial furnace for melting materials, the method comprising:
providing metal components including a metal floor and a metal sidewall;
covering an inner surface of the metal components with a refractory shell, the refractory shell having a floor refractory lining covering an inner surface of the metal floor and a sidewall refractory lining covering an inner surface of the metal sidewall such that a side pocket is defined between the metal sidewall and the sidewall refractory lining, the refractory shell having an inner surface that substantially defines a melting bath in which the materials are deposited for melting, the refractory shell being configured to inhibit exposure of the metal components to the materials; and
disposing a fill in the side pocket,
wherein 90% to 99.5% of the fill is composed of one or more magnesia materials selected from the group consisting of dead-burned magnesia and fused magnesia.

9. The method according to claim 8, wherein the disposing comprises pouring the fill into the side pocket while compacting the poured fill by one of vibration and tapping.

10. The method according to claim 9, wherein the side pocket has a width between the metal sidewall and the sidewall refractory lining in a range of 0.5 in to 1.0 in.

11. The method according to claim 8, wherein the metal sidewall and the metal floor define a metal shell.

12. A method of manufacturing an industrial furnace for melting materials, the method comprising:
providing metal components including a metal floor and a metal sidewall;
disposing a layer of fill on the metal floor;
covering an inner surface of the metal components with a refractory shell, the refractory shell having a floor refractory lining covering the fill layer and an inner surface of the metal floor to form a floor pocket between the metal floor and the floor refractory lining, the refractory shell further having a sidewall refractory lining covering an inner surface of the metal sidewall such that a side pocket is defined between the metal sidewall and the sidewall refractory lining, the refractory shell having an inner surface that substantially defines a melting bath in which the materials are deposited for melting, the refractory shell being configured to inhibit exposure of the metal components to the materials; and
disposing the fill in the side pocket,
wherein 90% to 99.5% of the fill is composed of one or more magnesia materials selected from the group consisting of dead-burned magnesia and fused magnesia.

13. The method according to claim 12, wherein the disposing of the layer of the fill comprises pouring the layer of the fill onto the metal floor while compacting the poured layer of fill by one of vibration and tapping, and
wherein the disposing of the fill in the side pocket comprises pouring the fill into the side pocket while compacting the fill by one of vibration and tapping.

14. The method according to claim 13, wherein the side pocket has a width between the metal sidewall and the sidewall refractory lining in a range of 0.5 in to 1.0 in.

15. The method according to claim 13, wherein the poured layer of the fill on the metal floor has a thickness in a range of 0.75 in to 2.0 in.

16. The method according to claim 12, wherein the metal sidewall and the metal floor define a metal shell.
